(19) United States
(12) Patent Application Publication
(10) Pub. No.: US 2026/0169217 A1
(43) Pub. Date: Jun. 18, 2026

(54) COMPONENT, AND METHOD FOR THE PRODUCTION THEREOF

(71) Applicant: HUMBOLDT-UNIVERSITÄT ZU BERLIN, Berlin (DE)

(72) Inventors: Matthias PLOCK, Berlin (DE); Tim SCHRÖDER, Berlin (DE); Julian BOPP, Schönefeld (DE)

(73) Assignee: HUMBOLDT-UNIVERSITÄT ZU BERLIN, Berlin (DE)

(21) Appl. No.: 19/103,778

(22) PCT Filed: Aug. 16, 2023
(86) PCT No.: PCT/DE2023/100602

§ 371 Date: Feb. 13, 2025

(30) Foreign Application Priority Data
Aug. 31, 2022 (DE) 10 2022 209 044.6

(51) Int. Cl. G02B 6/122; G02B 6/12; G02B 6/42

(52) U.S. Cl. CPC G02B 6/122; G02B 6/42; G02B 2006/12104

(57) ABSTRACT

The invention relates, inter alia, to a component (1) having at least one mirror (12). According to the invention, the mirror (12) has a sawtooth-shaped transition portion (122) comprising teeth (ZZ) which are interconnected via connecting portions (V) and are radially expanded in relation to the connecting portions (V); the radial width (ZW) of the teeth (ZZ) decreases in a specified direction, the radial width (SW) of the connecting portions (V) increases in the specified direction, and the tooth width (ZW) and the width (SW) of the connecting portion gradually become equal in the specified direction.

The invention relates to a component part with one or more mirrors. Such component parts are known, for example, from the US laid-open specification US 2012/099817 A1.

The invention is based on the object of further developing a component part of the type described with regard to low-loss coupling of other components such as integrated waveguides or optical fibers.

According to the invention, this object is achieved by a component part having the features as claimed in claim 1. Advantageous configurations of the component part according to the invention are specified in dependent claims.

According to the invention, at least one mirror has a sawtooth-shaped transition section, which has teeth which are connected to one another by connecting webs and are radially widened compared with the connecting webs, the radial tooth width of the teeth decreases in a specified direction, the radial web width of the connecting webs increases in the specified direction, and the tooth width and web width become aligned in the specified direction.

A significant advantage of the component part according to the invention can be considered to lie in the dual function of the sawtooth-shaped transition section: The sawtooth-shaped transition section has a mirror function due to its sawtooth shape; in addition, the sawtooth-shaped transition section generates an adiabatic transition from an optical Bloch mode to a waveguide mode due to its tapered shape and thus enables a reduction in coupling losses with respect to coupled components such as waveguides.

In a first particularly preferred configuration of the component part, the component part is a photon emitter having an active resonator section, which is provided with a first mirror at a first section end and with a second mirror at a second section end, wherein the first mirror has a smaller reflectance than the second mirror and forms a radiation output of the photon emitter, wherein the first mirror has the sawtooth-shaped transition section comprising a section end near the resonator section and a section end remote from the resonator section, the radial tooth width of the teeth decreases in the direction of the remote section end, the radial web width of the connecting webs increases in the direction of the remote section end, and the tooth width and web width become aligned in the direction of the remote section end. An advantage of this first configuration of the component part can also be considered to lie here in the dual function of the sawtooth-shaped transition section: The sawtooth-shaped transition section has a mirror function due to its sawtooth shape, which, together with the second mirror and any other mirror sections of the first mirror present, keeps the Purcell factor in the resonator section of the component part at a desired level; in addition, the sawtooth-shaped transition section generates an adiabatic transition from an optical Bloch mode to a waveguide mode due to its tapered shape and thus enables a reduction in coupling losses with respect to coupled components such as waveguides.

In a second particularly preferred configuration of the component part, the component part is a reflector, which is provided with said mirror at a first section end, which forms a radiation input and radiation output of the reflector, wherein the radial tooth width of the teeth decreases in the direction of the radiation input and radiation output, the radial web width of the connecting webs increases in the direction of the radiation input and radiation output, and the tooth width and web width become aligned in the direction of the radiation input and radiation output.

In a third particularly preferred configuration of the component part, the component part is a spin-state-dependent reflector with an active resonator section into which an optically active spin system is integrated and which is provided with a first mirror at a first section end and with a second mirror at a second section end, wherein the first mirror has a smaller reflectance than the second mirror and forms a radiation input and radiation output of the spin-state-dependent reflector, wherein the first mirror has the sawtooth-shaped transition section comprising a section end near the resonator section and a section end remote from the resonator section, the radial tooth width of the teeth decreases in the direction of the remote section end, the radial web width of the connecting webs increases in the direction of the remote section end, and the tooth width and web width become aligned in the direction of the remote section end.

In a fourth particularly preferred configuration of the component part, the component part is a band filter with a resonator section, which is provided with a first mirror at a first section end and with a second mirror at a second section end, wherein the first mirror forms a radiation output and the second mirror forms a radiation input, wherein both mirrors each have a sawtooth-shaped transition section, which has a section end near the resonator section and a section end remote from the resonator section, the radial tooth width of the teeth decreases in the direction of the remote section ends, the radial web width of the connecting webs increases in the direction of the remote section ends, and the tooth width and web width become aligned in the direction of the remote section ends.

The radial tooth width preferably corresponds to the distance between the tooth tip of the respective tooth and a (straight or curved) center axis of the taper section, which in turn corresponds to the beam direction of incoming or outgoing radiation of the component part, in particular in the direction of the radiation output of the component part; the same applies to the radial web width.

It is considered advantageous if the axial profile of the radial contour width of the sawtooth-shaped transition section(s) can be described by a mathematical function which is formed by a sine/cosine function or a potentiated sine/cosine function or at least contains a sine/cosine function and/or a potentiated sine/cosine function, as a function of the distance from the near section end or as a function of the distance from the radiation input or radiation output.

The radial contour width of the sawtooth-shaped transition section(s) preferably corresponds to the distance between the outer contour and the center axis of the transition section, which in turn preferably corresponds to the beam direction of outgoing radiation of the component part or the output direction in the direction of the radiation output.

The axial profile of the radial contour width of the sawtooth-shaped transition section(s) is preferably axially symmetrical with respect to the center axis.

It is also advantageous if each radial tooth width of each of the teeth corresponds to a width sum, which results from the summation of a specified tooth start value, a specified web start value, and a tooth-specific radial additional width.

In a configuration that is considered particularly advantageous, the tooth-specific additional width is defined by a polynomial function, preferably a polynomial function of at least the third degree.

Particularly good properties are obtained for the sawtooth-shaped transition section when the tooth-specific additional width is defined by the following equation:

$${A}_{i} = {A}_{0} {\sum }_{j = 0}^{3} {{c}_{j} ( \frac{M - i}{M} )}^{j}$$

wherein Aᵢ defines the tooth-specific radial additional width of the i-th tooth for i∈[1,M], A₀ defines the tooth start value, M defines the total number of teeth in the transition section, and cⱼ defines alignment factors; the count variable i is incremented with each tooth in the direction of the radiation input or radiation output or in the direction of the remote section end.

c₁ and c₂ are coefficients for which preferably:

$$\begin{matrix}- 1 < {c}_{1} < 1 \\ 0 < {c}_{2} < 10\end{matrix}$$

The coefficients c₁ and c₂ are preferably calculated in the context of an optimization on the basis of a simulation of the electric field of a geometry resulting from the abovementioned third-degree polynomial function with regard to a maximum coupling efficiency at one waveguide.

Within the scope of simulation calculations performed by the invention, the following suitable values for the coefficients c₁ and c₂ could be ascertained: c₁=0.275 and c₂=2.243.

The other two coefficients are preferably calculated according to:

$${c}_{0} = \frac{{A}_{m}}{{A}_{0}}$$

$$and$$

$${c}_{3} = 1 - {c}_{0} - {c}_{1} - {c}_{2}$$

wherein A_{M} defines an alignment value.

It is also considered advantageous if the axial profile of the radial contour width of the sawtooth-shaped transition section(s) consists of a specified number M of subsections. In the case of two or more sawtooth-shaped transition sections, each of the transition sections may have an individual value for M.

The following preferably applies for the contour profile of the outer contour of the i-th subsection, i∈[1,M]:

$${x}_{i} ( z ) = g + {A}_{0} + \{ \begin{matrix}{A}_{i - 1} [ 2 {cos}^{e} ( \frac{π}{a} \cdot z ) - 1 ] , & z \leq \frac{a}{2} \\ - {A}_{i - 1} + 2 ( {A}_{i - 1} - \frac{{A}_{i - 1} - {A}_{i}}{2} ) {cos}^{e} ( \frac{π}{a} \cdot z ) , & z > \frac{a}{2}\end{matrix}$$

wherein
z∈[0,a) is a location variable which defines, viewed in the axial direction, the location in the respective subsection,
xᵢ(z) denotes the radial contour width in the i-th subsection, i.e. the distance between the outer contour and the center axis of the i-th subsection,
Aᵢ denotes the radial tooth-specific additional width which describes the distance between the tooth tip of the i-th tooth and the center axis of the i-th subsection by A₀+Aᵢ+g,
Aᵢ₋₁ denotes the radial tooth-specific additional width which describes the distance between the tooth tip of the (i−1)-th tooth and the center axis of the i-th subsection by A₀+Aᵢ₋₁+g,
a denotes the axial length of the i-th subsection,
e denotes a specified straight exponent, and
g denotes a specified web start value.

A waveguide is preferably connected at the sawtooth-shaped transition section or at least at one of the sawtooth-shaped transition sections, in particular to the remote section end of the sawtooth-shaped transition section, or to the radiation input or to the radiation output. The width of the sawtooth-shaped transition section, in particular the remote section end of the sawtooth-shaped transition section, preferably corresponds, at least at the connection point to the waveguide, to the waveguide width of the waveguide.

The abovementioned alignment value is preferably dimensioned according to:

$${A}_{M} = {A}_{w} - {A}_{0} - g$$

wherein A_{w} describes the waveguide width at the connection point to the transition section.

It is considered advantageous if one of the mirrors or the first mirror additionally has a sawtooth-shaped connecting section. The sawtooth-shaped connecting section preferably has teeth with an identical radial tooth width.

The connecting section is preferably arranged between the sawtooth-shaped transition section and the resonator section (if present).

The number of teeth in the sawtooth-shaped connecting section and the number of teeth in the sawtooth-shaped transition section can influence, for example in the case of a photon emitter, the Purcell factor in the active resonator section and also the decoupling losses: The greater the number of teeth in the sawtooth-shaped connecting section, the greater the Purcell factor, but the coupling efficiency decreases when coupling to external components such as waveguides, because the influence of the tapered transition region becomes smaller; the smaller the number of teeth in the sawtooth-shaped connecting section and the larger the number of teeth in the sawtooth-shaped transition section, the greater the coupling efficiency when coupling to external components, but the Purcell factor decreases.

The width of the first tooth of the sawtooth-shaped transition section preferably corresponds to the identical tooth width of the connecting section.

The invention also relates to a method for producing a component part, in particular one as described above, wherein a mirror is produced. Such a method is also evident from the US laid-open specification US 2012/099817 A1 mentioned in the introductory part.

With regard to such a method, the mirror is provided according to the invention with a sawtooth-shaped transition section, which has, connected to one another by connecting webs, teeth which are radially widened compared with the connecting webs, the radial tooth width of the teeth decreases in a specified direction, the radial web width of the connecting webs increases in the specified direction, and the tooth width and web width become aligned in the specified direction. With regard to the advantages of the method according to the invention and its advantageous configurations, reference is made to the above statements in connection with the component part according to the invention and its advantageous configurations.

With regard to the optical properties of the component part, it is considered advantageous if the mirror is additionally equipped with a sawtooth-shaped connecting section. The sawtooth-shaped connecting section preferably has teeth with an identical radial tooth width.

The connecting section is preferably arranged between the sawtooth-shaped transition section and the active resonator section (if present).

It is particularly advantageous when, in the context of the method, the number of teeth in the sawtooth-shaped connecting section and the number of teeth in the sawtooth-shaped transition section and/or the ratio of the numbers in relation to one another are ascertained or optimized by simulation calculations, specifically with regard to a desired or specified minimum Purcell factor and a maximum possible coupling efficiency when coupling to a specified component, such as an integrated optical waveguide or an optical fiber.

Each tooth width of each of the teeth of the transition section is preferably dimensioned in such a way that the tooth width corresponds to a width sum of a specified tooth start value, a specified web start value, and a tooth-specific additional width, wherein the tooth-specific additional width is defined by the following equation:

$${A}_{i} = {A}_{0} {\sum }_{j = 0}^{3} {{c}_{j} ( \frac{M - i}{M} )}^{j}$$

with

$${c}_{0} = \frac{{A}_{m}}{{A}_{0}}$$

$$and$$

$${c}_{3} = 1 - {c}_{0} - {c}_{1} - {c}_{2}$$

wherein Aᵢ defines the tooth-specific radial additional width of the i-th tooth for i∈[1,M], A₀ defines the tooth start value, A_{M} defines an alignment value, M defines the total number of teeth in the transition section, and cⱼ defines alignment factors; and wherein the count variable i is incremented with each tooth in the direction of the remote section end.

The invention is explained in more detail below with reference to exemplary embodiments; here, by way of example,

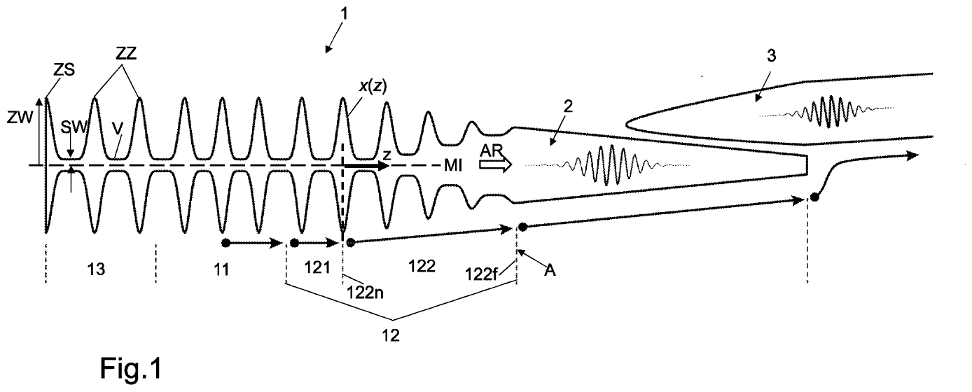

FIG. 1 shows an exemplary embodiment of a component part according to the invention in the form of a photon emitter in a top view,

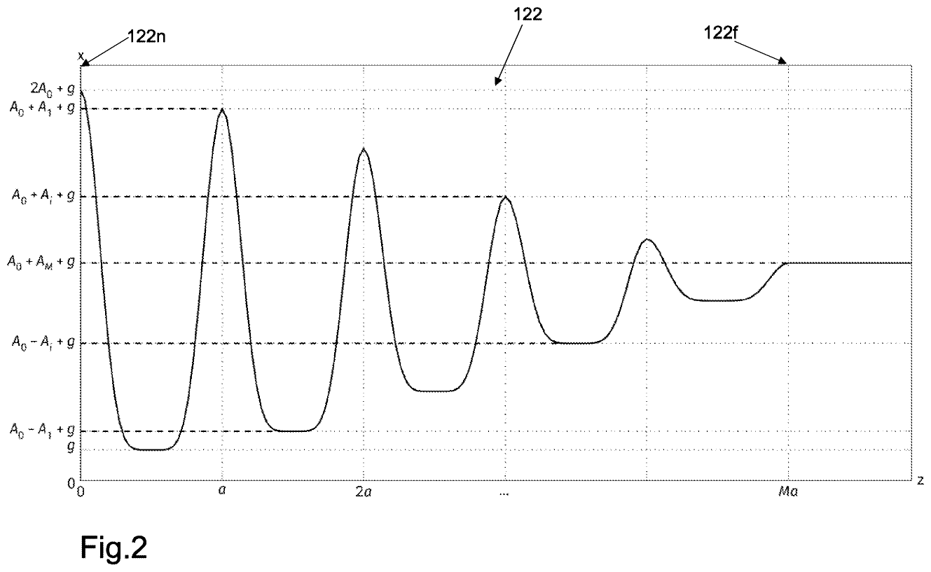

FIG. 2 shows, for example, a contour profile in a transition section of the component part according to FIGS. 1, 3 and 4, in more detail,

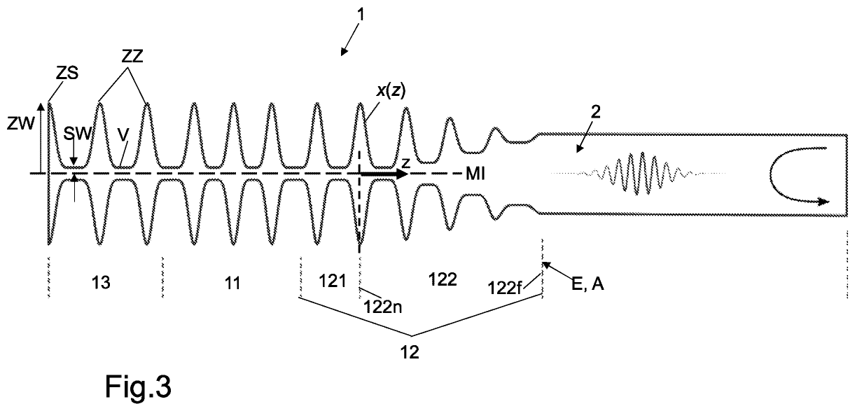

FIG. 3 shows an exemplary embodiment of a component part according to the invention in the form of a reflector in a top view, and

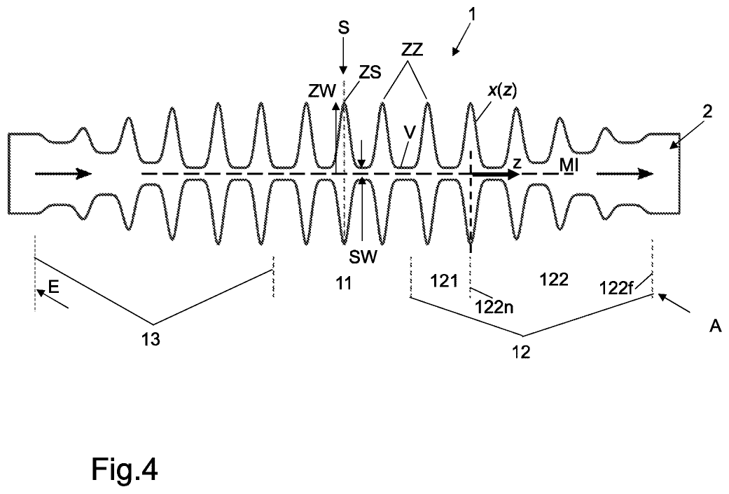

FIG. 4 shows an exemplary embodiment of a component part according to the invention in the form of a band filter in a top view.

FIG. 1 shows an exemplary embodiment of a component part 1 according to the invention in the form of a photon emitter in a simplified schematic top view. The photon emitter comprises an active sawtooth-shaped resonator section 11, which is provided with a first sawtooth-shaped mirror 12 at a first section end and with a second sawtooth-shaped mirror 13 at a second section end. The reflectance of the second mirror 13 is greater than that of the first mirror 12, so that the first mirror 12 forms a radiation output A of the photon emitter. The active resonator section 11 is preferably based on one or more negatively charged tin defects (SnV⁻), which are integrated in a diamond lattice and can emit single photons or entangled photons upon optical excitation.

The first mirror 12 has two sections, namely a sawtooth-shaped connecting section 121 and a sawtooth-shaped transition section 122. The sawtooth-shaped connecting section 121 is arranged between the sawtooth-shaped transition section 122 and the active resonator section 11.

The first and second mirrors 12 and 13 and the active resonator section 11 each have radially widened teeth ZZ, which are connected to one another by connecting webs V. In the exemplary embodiment according to FIG. 1, the radial tooth width ZW and the radial web width SW in the region of the connecting section 121 of the first mirror 12, of the active resonator section 11 and of the second mirror 13 are respectively constant; the radial tooth and web width SW can be identical in each of said sections or have a section-specific value in each section.

The sawtooth-shaped transition section 122 is connected to a section end 122n near the resonator section 11 at the sawtooth-shaped connecting section 121; the section end 122f of the sawtooth-shaped transition section 122, which is remote from the resonator section 11, forms the radiation output A of the photon emitter.

The sawtooth-shaped transition section 122 is also equipped with connecting webs V and radially widened teeth ZZ, wherein, in contrast to the connecting section 121, the radial tooth width ZW of the teeth ZZ decreases in the direction of the remote section end 122f or in the emission direction AR of the output radiation. The radial web width SW of the connecting webs V increases in the direction of the remote section end 122f, so that the tooth width ZW and web width SW become aligned in the direction of the remote section end 122f.

The radial tooth width ZW is defined here by the distance between the tooth tip ZS of the respective tooth ZZ and a (straight or curved) center axis MI of the respective section; the same applies to the radial web width SW.

At the remote section end 122f of the sawtooth-shaped transition section 122, an untapered or tapered waveguide 2 is connected in the exemplary embodiment according to FIG. 1. The width of the remote section end 122f of the transition section 122 corresponds to the waveguide width of the waveguide 2 at the coupling point in order to minimize coupling losses at this interface. The tapered waveguide 2 tapers in the emission direction AR in order to optimize coupling with an oppositely tapered optical fiber 3, that is, an optical fiber widening in the emission direction AR.

FIG. 2 shows in a more detailed illustration a particularly preferred axial profile, i.e. seen in the beam direction or along the center axis MI, of the radial contour width x(z) of the sawtooth-shaped transition section 122 (for the exemplary embodiments according to FIGS. 1, 3 and 4); in this case, the near section end 122n is defined by z=0 and the remote section end 122f by z=M*a, wherein a indicates the length of subsections of the transition section 122 in the beam direction and M indicates the number of subsections. M is selected as an example in FIG. 2 for illustrative purposes and is generally between 10 and 30 for optimal configurations.

It can be seen that the contour is “sinusoidal” and that the contour width can be described by a mathematical function which is formed by a sine/cosine function or a potentiated sine/cosine function or contains at least one sine/cosine function and/or one potentiated sine/cosine function, depending on the distance z from the near section end 122n.

The radial contour width x(z) of the sawtooth-shaped transition section 122 is defined in FIG. 2 by the distance between the outer contour and the center axis MI of the transition section 122, which in turn corresponds to the emission direction AR of radiation outgoing from the photon emitter; in the region of the teeth ZZ, the radial contour width x(z) therefore corresponds to the tooth width ZW between the tooth tip ZS and the center axis MI in FIG. 1.

The axial profile of the radial contour width x(z) or the arrangement and size of the teeth ZZ of the sawtooth-shaped transition section 122 is axially symmetrical with respect to the center axis MI; the same also applies to the arrangement and configuration of the teeth ZZ and connecting webs V in the remaining sections, i.e. for the second mirror 13, the resonator section 11, and the connecting section 121.

In the configuration of the teeth ZZ according to FIG. 2, each radial tooth width ZW of each of the teeth ZZ corresponds to a width sum, which results from the summation of a specified tooth start value, a specified web start value, and a tooth-specific radial additional width; the tooth-specific additional width is defined by a polynomial function of at least the third degree.

The axial profile (along the location variable z) of the radial contour width x(z) of the sawtooth-shaped transition section 122 consists in the exemplary embodiment according to FIGS. 1 and 2 of a specified number M of subsections, where the following applies to the contour profile of the outer contour of the i-th subsection, i∈[1,M]:

$${x}_{i} ( z ) = g + {A}_{0} + \{ \begin{matrix}{A}_{i - 1} [ 2 {cos}^{e} ( \frac{π}{a} \cdot z ) - 1 ] , & z \leq \frac{a}{2} \\ - {A}_{i - 1} + 2 ( {A}_{i - 1} - \frac{{A}_{i - 1} - {A}_{i}}{2} ) {cos}^{e} ( \frac{π}{a} \cdot z ) , & z > \frac{a}{2}\end{matrix}$$

wherein z∈[0,a) is the location variable that defines the location in each subsection when viewed in the axial direction, xᵢ(z) denotes the radial contour width in the i-th subsection, i.e. the distance between the outer contour and the center axis of the i-th subsection, A₀ denotes a tooth start value, Aᵢ (i∈[1,M]) denotes the radial tooth-specific additional width which describes the distance between the tooth tip of the i-th tooth and the center axis MI of the i-th subsection by A₀+Aᵢ+g, Aᵢ₋₁ denotes the radial tooth-specific additional width which describes the distance between the tooth tip of the (i−1)-th tooth and the center axis of the i-th subsection by A₀+Aᵢ₋₁+g, a denotes the axial length of the i-th subsection, e denotes a specified straight exponent and g denotes a specified web start value.

The tooth-specific additional width fulfills the following conditions:

$${A}_{i} = {A}_{0} {\sum }_{j = 0}^{3} {{c}_{j} ( \frac{M - i}{M} )}^{j}$$

with

$${c}_{0} = \frac{{A}_{m}}{{A}_{0}}$$

$$and$$

$${c}_{3} = 1 - {c}_{0} - {c}_{1} - {c}_{2}$$

wherein A_{M} defines an alignment value and cⱼ defines alignment factors, and wherein the count variable i is incremented with each tooth or subsection in the direction of the remote section end. c₁ and c₂ are coefficients of −1<c₁<1 and 0<c₂<10, which are calculated in the context of an optimization based on a simulation of the electric field of a geometry resulting from the abovementioned third-degree polynomial function with regard to a maximum coupling efficiency to a waveguide and, for example, c₁=0.275 and c₂=2.243.

In order to ensure a seamless transition between the transition section 122 and the waveguide 2, the alignment value A_{M} is preferably dimensioned according to:

$${A}_{M} = {A}_{w} - {A}_{0} - g$$

wherein A_{w} describes the waveguide width of the waveguide 2 at the connection point to the transition section 122.

FIG. 3 shows an exemplary embodiment of a component part 1 according to the invention in the form of a reflector in a simplified schematic top view. The reflector is provided with a mirror 12, which forms both a radiation input E and a radiation output A of the reflector. The radial tooth width ZW of the teeth ZZ decreases in the direction of the radiation input E and the radiation output A; the radial web width SW of the connecting webs V increases in this direction, so that the tooth width ZW and the web width SW become aligned. The opposite other section end of the reflector is provided with a second mirror 13.

FIG. 4 shows an exemplary embodiment of a component part 1 according to the invention in the form of a band filter in a simplified schematic top view. The band filter is equipped with a resonator section 11, which is provided with a first mirror 12 at a first section end and with a second mirror 13 at a second section end. The first mirror 12 forms a radiation output A, and the second mirror forms a radiation input E; S designates an axis of symmetry of the band filter, so that the first and second mirrors are identical in construction.

The mirrors 12 and 13 each have a sawtooth-shaped transition section 122 (marked in FIG. 4 only for the first mirror 12 because of the symmetry), which comprises a section end 122n near the resonator section 11 and a section end 122f remote from the resonator section 11. The radial tooth width ZW of the teeth ZZ decreases in the direction of the remote section ends 122f. The radial web width SW of the connecting webs V increases in the direction of the remote section ends 122f, wherein the tooth width ZW and web width SW become aligned in the direction of the remote section ends 122f.

Finally, it should be mentioned that the features of all the exemplary embodiments described above can be combined with one another in any manner to form further other exemplary embodiments of the invention.

Also, all the features of dependent claims can be combined individually with each of the coordinate claims, i.e. each individually or in any combination with one or more other dependent claims, in order to obtain further other exemplary embodiments.

1. A component part (1) having at least one mirror (12),
characterized in that
the mirror (12) has a sawtooth-shaped transition section (122), which has teeth (ZZ) which are connected to one another by connecting webs (V) and are radially widened compared with the connecting webs (V),
the radial tooth width (ZW) of the teeth (ZZ) decreases in a specified direction,
the radial web width (SW) of the connecting webs (V) increases in the specified direction, and
the tooth width (ZW) and web width (SW) become aligned in the specified direction.

2. The component part (1) as claimed in claim 1,
characterized in that
the component part is a photon emitter having an active resonator section (11), which is provided with the mirror as the first mirror (12) at a first section end and with a second mirror (13) at a second section end, wherein the first mirror (12) has a smaller reflectance than the second mirror (13) and forms a radiation output (A) of the photon emitter (1),
wherein
the first mirror (12) has the sawtooth-shaped transition section (122) comprising a section end (122n) near the resonator section (11) and a section end (122f) remote from the resonator section (11),
the radial tooth width (ZW) of the teeth (ZZ) decreases in the direction of the remote section end (122f),
the radial web width (SW) of the connecting webs (V) increases in the direction of the remote section end (122f), and
the tooth width (ZW) and web width (SW) become aligned in the direction of the remote section end (122f).

3. The component part (1) as claimed in claim 1,
characterized in that
the component part is a reflector, which is provided with said mirror (12) at a first section end, which forms a radiation input (E) and radiation output (A) of the reflector,
wherein
the radial tooth width (ZW) of the teeth (ZZ) decreases in the direction of the radiation input (E) and radiation output (A),
the radial web width (SW) of the connecting webs (V) increases in the direction of the radiation input (E) and radiation output (A), and
the tooth width (ZW) and web width (SW) become aligned in the direction of the radiation input (E) and radiation output (A).

4. The component part (1) as claimed in claim 1,
characterized in that
the component part is a spin-state-dependent reflector provided with an active resonator section (11) into which an optically active spin system is integrated and which is provided with the mirror as the first mirror (12) at a first section end and with a second mirror (13) at a second section end, wherein the first mirror (12) has a smaller reflectance than the second mirror (13) and forms a radiation input (E) and radiation output (A) of the spin-state-dependent reflector,
wherein
the first mirror (12) has the sawtooth-shaped transition section (122) comprising a section end (122n) near the resonator section (11) and a section end (122f) remote from the resonator section (11),
the radial tooth width (ZW) of the teeth (ZZ) decreases in the direction of the remote section end (122f),
the radial web width (SW) of the connecting webs (V) increases in the direction of the remote section end (122f), and
the tooth width (ZW) and web width (SW) become aligned in the direction of the remote section end (122f).

5. The component part (1) as claimed in claim 1,
characterized in that
the component part is a band filter with a resonator section (11), which is provided with the mirror as the first mirror (12) at a first section end and with a second mirror (13) at a second section end, wherein the first mirror (12) forms a radiation output (A) and the second mirror (13) forms a radiation input (E),
wherein
both mirrors (12, 13) each have a sawtooth-shaped transition section (122), which has a section end (122n) near the resonator section (11) and a section end (122f) remote from the resonator section (11),
the radial tooth width (ZW) of the teeth (ZZ) decreases in the direction of the remote section ends (122f),
the radial web width (SW) of the connecting webs (V) increases in the direction of the remote section ends (122f), and
the tooth width (ZW) and web width (SW) become aligned in the direction of the remote section ends (122f).

6. The component part (1) as claimed in claim 1,
characterized in that
the axial profile of the radial contour width of the sawtooth-shaped transition section(s) (122) can be described by a mathematical function which is formed by a sine/cosine function or a potentiated sine/cosine function or contains at least one sine/cosine function and/or one potentiated sine/cosine function, as a function of the distance from the near section end (122n) or as a function of the distance from the radiation input or radiation output.

7. The component part (1) as claimed in claim 1,
characterized in that
the axial profile of the radial contour width of the sawtooth-shaped transition section(s) (122) is axially symmetrical with respect to the center axis (MI).

8. The component part (1) as claimed in claim 1,
characterized in that
each radial tooth width (ZW) of each of the teeth (ZZ) corresponds to a width sum, which results from the summation of a specified tooth start value, a specified web start value, and a tooth-specific radial additional width.

9. The component part (1) as claimed in claim 8,
characterized in that
the tooth-specific additional width is defined by a polynomial function, preferably a polynomial function of at least the third degree.

10. The component part (1) as claimed in claim 8,
characterized in that
the tooth-specific additional width is defined by the following equation:
$${A}_{i} = {A}_{0} {\sum }_{j = 0}^{3} {{c}_{j} ( \frac{M - i}{M} )}^{j}$$
with
$${c}_{0} = \frac{{A}_{m}}{{A}_{0}}$$
$$and$$
$${c}_{3} = 1 - {c}_{0} - {c}_{1} - {c}_{2}$$
wherein Aᵢ defines the tooth-specific radial additional width of the i-th tooth (ZZ) for i∈[1,M], A₀ defines the tooth start value, A_{M} defines an alignment value, M defines the total number of teeth (ZZ) in the transition section (122), and cⱼ defines alignment factors; and
wherein the count variable i is incremented with each tooth in the direction of the radiation output (A), the radiation input (E) or in the direction of the remote section end (122f).

11. The component part (1) as claimed in claim 1,
characterized in that
the axial profile of the radial contour width of the sawtooth-shaped transition section(s) (122) consists of a specified number M of subsections, wherein the following applies to the contour profile of the outer contour of the i-th subsection, i−[1,M]:
$${x}_{i} ( z ) = g + {A}_{0} + \{ \begin{matrix}{A}_{i - 1} [ 2 {cos}^{e} ( \frac{π}{a} \cdot z ) - 1 ] , & z \leq \frac{a}{2} \\ - {A}_{i - 1} + 2 ( {A}_{i - 1} - \frac{{A}_{i - 1} - {A}_{i}}{2} ) {cos}^{e} ( \frac{π}{a} \cdot z ) , & z > \frac{a}{2}\end{matrix}$$
wherein
z∈[0,a) is a location variable which defines, viewed in the axial direction, the location in the respective subsection,
xᵢ(z) denotes the radial contour width in the i-th subsection, i.e. the distance between the outer contour and the center axis (MI) of the i-th subsection,
Aᵢ denotes the radial tooth-specific additional width which describes the distance between the tooth tip of the i-th tooth (ZZ) and the center axis (MI) of the i-th subsection by A₀+Aᵢ+g,
Aᵢ₋₁ denotes the radial tooth-specific additional width which describes the distance between the tooth tip of the (i−1)-th tooth (ZZ) and the center axis (MI) of the i-th subsection by A₀+Aᵢ₋₁+g,
a denotes the axial length of the i-th subsection,
e denotes a specified straight exponent, and
g denotes a specified web start value.

12. The component part (1) as claimed in claim 1,
characterized in that
a waveguide (2) is connected at the sawtooth-shaped transition section (122) or at least at one of the sawtooth-shaped transition sections (122), in particular to the remote section end (122f) of the sawtooth-shaped transition section (122), or to the radiation input or to the radiation output, and
the width of the sawtooth-shaped transition section (122), in particular the width of the remote section end (122f) of the sawtooth-shaped transition section (122), corresponds to the waveguide width of the waveguide (2), at least at the connection point between the waveguide and the transition section (122).

13. The component part (1) as claimed in claim 12,
characterized in that
the alignment value is dimensioned according to:
$${A}_{M} = {A}_{w} - {A}_{0} - g$$
wherein A_{w} describes the waveguide width at the connection point to the transition section (122).

14. The component part (1) as claimed in claim 1,
characterized in that
at least one of the mirrors or the first mirror (12) can additionally have a sawtooth-shaped connecting section (121),
the sawtooth-shaped connecting section (121) has teeth (ZZ) with an identical radial tooth width (ZW), and
the width of the first tooth (ZZ) of the sawtooth-shaped transition section (122) corresponds to the identical tooth width (ZW) of the connecting section (121).

15. A method for producing a component part (1), in particular one as claimed in any of the preceding claims, wherein at least one mirror is produced,
characterized in that
the mirror (12) is provided with a sawtooth-shaped transition section (122), which has teeth (ZZ) which are connected to one another by connecting webs (V) and are radially widened compared with the connecting webs (V),
the radial tooth width (ZW) of the teeth (ZZ) decreases in a specified direction,
the radial web width (SW) of the connecting webs (V) increases in the specified direction, and
the tooth width (ZW) and web width (SW) become aligned in the specified direction.

16. The method as claimed in claim 15,
characterized in that
each tooth width (ZW) of each of the teeth (ZZ) of the transition section (122) is dimensioned in such a way that the tooth width (ZW) corresponds to a width sum of a specified tooth start value, a specified web start value, and a tooth-specific additional width, wherein the tooth-specific additional width is defined by the following equation:
$${A}_{i} = {A}_{0} {\sum }_{j = 0}^{3} {{c}_{j} ( \frac{M - i}{M} )}^{j}$$
with
$${c}_{0} = \frac{{A}_{m}}{{A}_{0}}$$
$$and$$
$${c}_{3} = 1 - {c}_{0} - {c}_{1} - {c}_{2}$$
wherein Aᵢ defines the tooth-specific radial additional width of the i-th tooth (ZZ) for i∈[1,M], A₀ defines the tooth start value, A_{M} defines an alignment value, M defines the total number of teeth (ZZ) in the transition section (122), and cⱼ defines alignment factors; and
wherein the count variable i is incremented with each tooth in the direction of the radiation input or output or in the direction of the remote section end (122f).
